(19) United States
(12) Patent Application Publication
(10) Pub. No.: US 2024/0032002 A1
(43) Pub. Date: Jan. 25, 2024

(54) DYNAMIC RESOURCE ALLOCATION

(71) Applicant: Apple Inc., Cupertino, CA (US)

(72) Inventors: Xiaolong Tu, Shanghai (CN); Kai Zhang, Beijing (CN); Lele Cui, Beijing (CN); Lijie Zhang, Beijing (CN)

(73) Assignee: Apple Inc., Cupertino, CA (US)

(21) Appl. No.: 18/349,085

(22) Filed: Jul. 7, 2023

Related U.S. Application Data
(60) Provisional application No. 63/389,805, filed on Jul. 15, 2022.

(51) Int. Cl. H04W 72/0446; H04W 72/56

(52) U.S. Cl. CPC H04W 72/0446; H04W 72/56

(57) ABSTRACT

Provided is a method for a user equipment (UE). The UE obtains a slot allocation information from a network device. The slot allocation information indicates a first slot and a second slot. The first slot is configured to communicate voice traffic and the second slot is configured to communicate traffic other than voice. The UE communicates the voice traffic in the first slot and the traffic other than voice in the second slot.

### CROSS-REFERENCE TO RELATED APPLICATION

This application claims the benefit of U.S. Provisional Patent Application No. 63/389,805, filed on Jul. 15, 2022, which is herein incorporated by reference in its entirety for all purposes.

### TECHNICAL FIELD

This application relates generally to wireless communication systems, and more specifically to dynamic resource allocation.

### BACKGROUND OF THE INVENTION

Wireless mobile communication technology uses various standards and protocols to transmit data between a base station and a wireless mobile device. Wireless communication system standards and protocols can include the 3rd Generation Partnership Project (3GPP) long term evolution (LTE); fifth-generation (5G) 3GPP new radio (NR) standard; the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, new radio (NR) node or g Node B (gNB), which communicate with a wireless communication device, also known as user equipment (UE).

### BRIEF SUMMARY OF THE INVENTION

According to an aspect of the present disclosure, a method for a user equipment (UE) is provided that includes: obtaining a slot allocation information from a network device, wherein the slot allocation information indicates a first slot and a second slot, and wherein the first slot is configured to communicate voice traffic and the second slot is configured to communicate traffic other than voice; and communicating the voice traffic in the first slot and the traffic other than voice in the second slot.

According to an aspect of the present disclosure, a method for a network device is provided that includes: generating a slot allocation information for transmission to a user equipment (UE), wherein the slot allocation information indicates a first slot and a second slot, and wherein the first slot is configured to communicate voice traffic and the second slot is configured to communicate traffic other than voice; and communicating the voice traffic in the first slot and the traffic other than voice in the second slot.

According to an aspect of the present disclosure, a computer program product is provided that includes computer programs which, when executed by one or more processors, cause an apparatus to perform steps of: obtaining a slot allocation information from a network device, wherein the slot allocation information indicates a first slot and a second slot, and wherein the first slot is configured to communicate voice traffic and the second slot is configured to communicate traffic other than voice; and communicating the voice traffic in the first slot and communicating the traffic other than voice in the second slot.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a user equipment (UE) in accordance with some embodiments.

FIG. 2 illustrates a flowchart for an exemplary method for a user equipment in accordance with some embodiments.

FIG. 3A illustrates an exemplary diagram for voice specific slot and common slot within a CDRX period in accordance with some embodiments.

FIG. 3B illustrates another exemplary diagram for voice specific slot and common slot within a CDRX period in accordance with some embodiments.

FIG. 4 illustrates a flowchart for an exemplary method for a network device in accordance with some embodiments.

FIG. 5 illustrates a flowchart for exemplary steps for dynamic resource allocation in accordance with some embodiments.

FIG. 6 illustrates another flowchart for exemplary steps for dynamic resource allocation in accordance with some embodiments.

FIG. 7 illustrates an exemplary block diagram of an apparatus for a UE in accordance with some embodiments.

FIG. 8 illustrates an exemplary block diagram of an apparatus for a network device in accordance with some embodiments.

FIG. 9 illustrates example components of a device in accordance with some embodiments.

FIG. 10 illustrates example interfaces of baseband circuitry in accordance with some embodiments.

FIG. 11 illustrates components in accordance with some embodiments.

FIG. 12 illustrates an architecture of a wireless network in accordance with some embodiments.

### DETAILED DESCRIPTION OF THE INVENTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

In wireless communication, there are voice traffic and other traffic. The voice traffic is a kind of instant traffic. Compared with non-instant traffic, such as message, e-mail, etc., the instant traffic (e.g., the voice traffic) requires a higher quality of communication.

In related technologies, the wireless network does not differentiate voice traffic and other traffic. That means, a common slot may be used to enable communications between UE(s) and network device(s) for both the voice traffic and the other traffic. As a result, the voice traffic and the other traffic cannot be configured respectively.

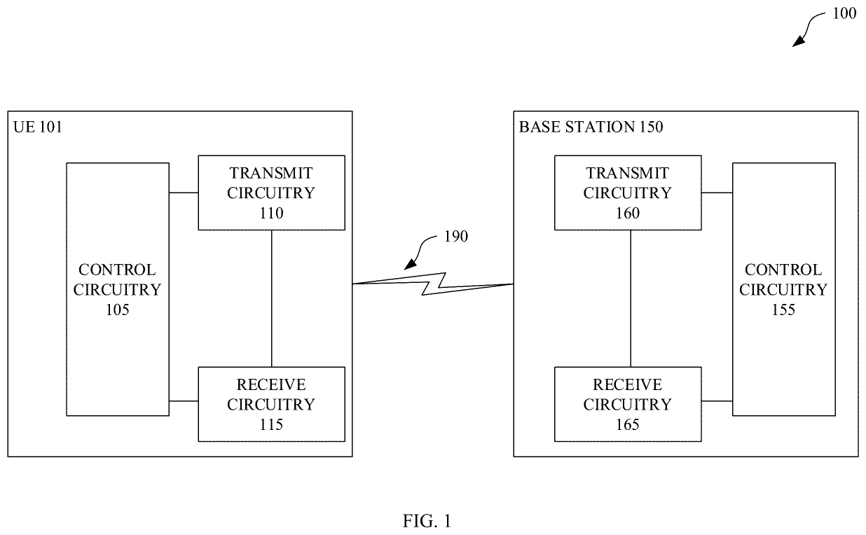

FIG. 1 illustrates a wireless network 100, in accordance with some embodiments. The wireless network 100 includes a UE 101 and a base station 150 connected via an air interface 190.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120-degree area with an array of antennas directed to each sector to provide 360-degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with MTC. In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuitry 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g., messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person-to-person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is included of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is included of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

The UE and the network device described in the following embodiments may be implemented by the UE 101 and the base station 150 described in FIG. 1.

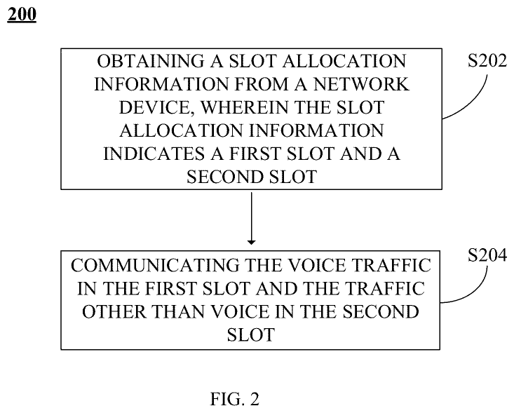

FIG. 2 illustrates a flowchart for an exemplary method for a user equipment in accordance with some embodiments. The method 200 illustrated in FIG. 2 may be implemented by the UE 101 described in FIG. 1.

In some embodiments, the method 200 for UE may include the following steps: S202, obtaining a slot allocation information from a network device, wherein the slot allocation information indicates a first slot and a second slot, and wherein the first slot is configured to communicate voice traffic and the second slot is configured to communicate traffic other than voice; and S204, communicating the voice traffic in the first slot and the traffic other than voice in the second slot.

According to some embodiments of the present disclosure, by obtaining a slot allocation information indicating a first slot for voice traffic and a second slot for other traffic from a network device, a UE can be configured to communicate the voice traffic and the traffic other than voice in different slots. Accordingly, the voice traffic and the traffic other than voice can be configured respectively, which enables further configuration of one or more parameters of different slots, thereby achieving dynamic resource allocation to improve voice quality.

In the following, each step of the method 200 will be described in detail.

At step S202, the UE obtains a slot allocation information from a network device, wherein the slot allocation information indicates a first slot and a second slot, and wherein the first slot is configured to communicate voice traffic and the second slot is configured to communicate traffic other than voice.

At step S204, UE communicates the voice traffic in the first slot and the traffic other than voice in the second slot.

Note that the terms “communicate”, “communicating” and “communication” in the present disclosure includes bidirectional communication, i.e., both transmitting and receiving. For example, UE communicates the voice traffic in the first slot and the traffic other than voice in the second slot means UE transmits and/or receives the voice traffic in the first slot and the UE transmits and/or receives the traffic other than voice in the second slot. As another example, the network device communicates the voice traffic in the first slot and the traffic other than voice in the second slot means the network device transmits and/or receives the voice traffic in the first slot and the network device transmits and/or receives the traffic other than voice in the second slot.

According to some embodiments, the first slot is voice specific slot, and the second slot is slot for traffic other than voice. In other words, the first slot is only used for communicating voice traffic while the second slot is a common slot for other traffic.

In some embodiments, the first slot is a virtual slot. In other words, the first slot may not be a physical slot. Generally, a physical slot may be a fixed slot of an OnDuration time window within a connected mode discontinuous reception (CDRX) period. For example, a physical slot may refer to the first slot of the OnDuration time window, the second slot of the OnDuration time window and so on.

In some embodiments, compared with the physical slot, the virtual slot may be a flexible slot of the OnDuration time window within the CDRX period. In other words, in each CDRX period, the virtual slot may be pre-allocated within the OnDuration window, but the specific temporal position of the virtual slot could be dynamically selected within the OnDuration window according to actual need or actual condition. For example, the above-mentioned first slot, as a virtual slot, may be pre-allocated within the OnDuration window in CDRX period, which means there is a slot specific to voice traffic, but which specific physical slot within the OnDuration window is not pre-allocated.

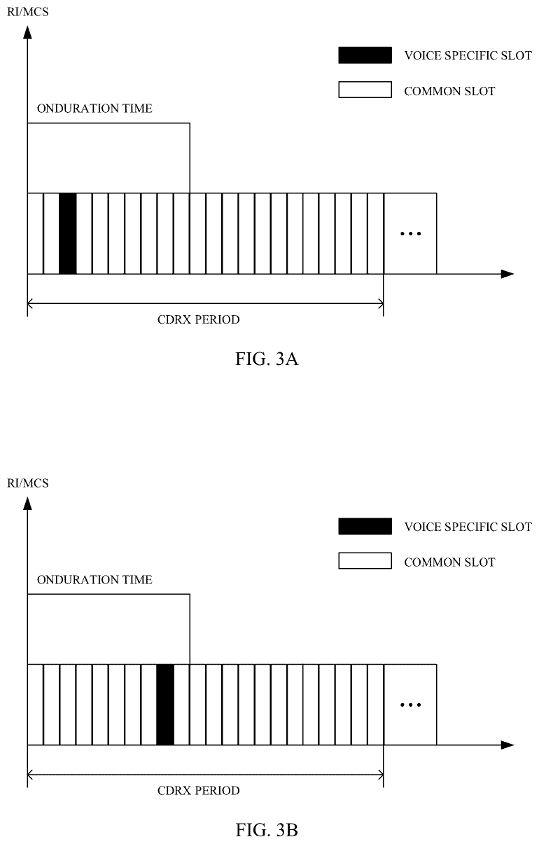

FIG. 3A illustrates an exemplary diagram for voice specific slot and common slot within a CDRX period in accordance with some embodiments and FIG. 3B illustrates another exemplary diagram for voice specific slot and common slot within a CDRX period in accordance with some embodiments.

As shown in FIGS. 3A and 3B, the exemplary OnDuration time lasts 10 physical slots. Among these 10 physical slots in OnDuration time, the block in black represents the voice specific slot in which the voice traffic is communicated between the UE and the network device, and the block in white represents the common slot in which the traffic other than voice is communicated between the UE and the network device.

As can be seen from FIGS. 3A and 3B that the voice specific slot (e.g., the first slot) is a virtual slot which may be any slot of an OnDuration time window within the CDRX period. For example, according to some embodiments shown in FIG. 3A, the voice specific slot (e.g., the first slot) may be the third slot of the OnDuration time window, while according to some embodiments shown in FIG. 3B, the voice specific slot (e.g., the first slot) may be the ninth slot of the OnDuration time window.

According to some embodiments, a first slot is not necessarily mean one first slot but may refer to a plurality of first slots that are configured to communicate voice traffic. That is, there may be more than one first slots (e.g., 2, 3, 4, 5, . . . , etc.) within the OnDuration time window of a CDRX period. It should be noted that when a first slot refers to a plurality of first slots, these slots may be adjacent slots or separated slots.

According to some embodiments, a second slot is not necessarily mean one second slot but may also refer to a plurality of second slots that are configured to communicate traffic other than voice. That is, there may be more than one second slots (e.g., 2, 3, 4, 5, . . . , etc.) within the OnDuration time window of a CDRX period. Like the first slot, when a second slot refers to a plurality of second slots, these slots may be adjacent slots or separated slots.

According to some embodiments of the present disclosure, the voice specific slot (i.e., the first slot) could be dynamically selected within an OnDuration window, which increases the flexibility of the voice specific slot.

In some embodiments, a cycle of the first slot is aligned with a connected mode discontinuous reception (CDRX) period. For example, the CDRX period may be X milliseconds (ms), and the cycle of the first slot may also be X milliseconds (ms), where X may be a positive real number.

According to some embodiments, the cycle of the first slot may correspond to the CDRX period. According to some embodiments, there is at least one first slot within a CDRX period. According to some embodiments, for different CDRX periods, the voice specific slot (i.e., the first slot) may always be the third slot of OnDuration time window in each CDRX period. According to some embodiments, the voice specific slot (i.e., the first slot) may be the third slot of OnDuration time window for the first CDRX period and may be the fifth slot of OnDuration time window for the second CDRX period. However, the present disclosure does not limit to this. According to some embodiments, the temporal position of the voice specific slot (i.e., the first slot) could be any slot of OnDuration time window according to actual need and/or actual condition.

According to some embodiments of the present disclosure, by aligning the cycle of the voice specific slot (i.e., the first slot) with the CDRX period, voice quality can be improved per CDRX period.

According to some embodiments, the network device may schedule a high rank for both voice traffic and other traffic (e.g., up to 4 layers, 6 layers, 8 layers, etc.). However, small voice packet size with high rank needs few RB number (e.g., low to 1 PRB), and physical downlink share channel (PDSCH) is easy to fail with serious frequency selective fading and voice packet loss is increased due to aggressive rank.

Note that the “aggressive rank” is named relative to a “conservative rank”. The aggressive rank is usually higher than the conservative rank under a same circumstance. For example, in some circumstances, the aggressive rank may refer to 3 or 4 layers while the conservative rank may refer to 1 or 2 layers. As another example, in some circumstances, the aggressive rank may refer to 5 or 6 layers while the conservative rank may refer to 3 or 4 layers.

In some embodiments, the method 200 may further include: obtaining, from the network device, a rank allocation information, wherein the rank allocation information indicates a first rank for the first slot and a second rank for the second slot, and wherein the first rank is smaller than the second rank, wherein communicating the voice traffic in the first slot further includes: communicating the voice traffic in the first slot based on the first rank.

In the present disclosure, “rank” is used for space division multiplexing (SDM) which specifically indicates that the same time-frequency resources may be divided into several portions in space and thus may be transmitted simultaneously through these different portions in space. The basic unit for “rank” may be a layer. For example, rank 1 means one layer, rank 2 means two layers, rank 3 means three layers, . . . , etc. Generally, under the condition that the time-frequency resources are constant, the higher the rank is, the higher the throughput rate is.

According to some embodiments, the rank allocation information obtained from the network device may indicate a first rank for the first slot and a second rank for the second slot, wherein the first rank is less than the second rank. In other words, compared with the second rank, the first rank for voice transmission is a conservative rank. Meanwhile, compared with the first rank, the second rank an aggressive rank.

According to some embodiments, first rank may be differently configured for different first slots. For example, the first slot in the first CDRX period may be allocated with a first rank of 1 layer, while the first slot in second CDRX period may be allocated with a first rank of 2 layers. As another example, the first slot in each CDRX period may be allocated with a first rank of 2 layers. Note that although the first rank for different first slots in different CDRX periods may be different, in each CDRX period, the first rank for voice traffic is always less than the second rank for the traffic other than voice.

According to some embodiments of the present disclosure, a conservative rank (i.e., the first rank) can be applied for voice traffic in the first slot. In this way, voice traffic can be communicated through a conservative rank, which reduces voice packet loss and/or fast fading and improves voice quality.

In some embodiments, the method 200 may further include: obtaining, from the network device, a rank allocation information, wherein the rank allocation information indicates a first rank for the first slot and a second rank for the second slot, and wherein the first rank is smaller than the second rank, wherein communicating the traffic other than voice in the second slot further includes: communicating the traffic other than voice in the second slot based on the second rank.

According to some embodiments of the present disclosure, a conservative rank (i.e., the first rank) can be applied for voice traffic in the first slot and an aggressive rank (i.e., the second rank) can be applied for other traffic in the second slot, which reduces voice packet loss and/or fast fading and preserves the throughout rate for traffic other than voice at the same time.

According to some embodiments, “modulation and coding scheme (MCS)” is a representation to characterize the communication rate. The MCS takes the concerned factors affecting the communication rate as the columns of the table and the MCS indexes as the rows to form a rate table. Therefore, each MCS index corresponds to a physical throughout rate under a set of parameters. However, small voice packet size with high MCS needs few resource block (RB) number (e.g., low to 1 PRB), and PDSCH is easy to fail with serious frequency selective fading and voice packet loss is increased due to aggressive MCS.

Note that the term “aggressive MCS” is named relative to the term “conservative MCS” and indicates that the aggressive MCS is usually higher than the conservative MCS under a same circumstance. For example, in some circumstances, the aggressive MCS may refer to 25 while the conservative MCS may refer to 23. As another example, in some circumstances, the aggressive MCS may refer to 15 while the conservative MCS may refer to 13.

In some embodiments, the method 200 may further include: obtaining, from the network device, a modulation and coding scheme (MCS) allocation information, wherein the MCS allocation information indicates a first MCS for the first slot and a second MCS for the second slot, and wherein the first MCS is less than the second MCS, wherein communicating the voice traffic in the first slot further includes: communicating the voice traffic in the first slot based on the first MCS.

As used herein, “MCS” may refer to the MCS index. Generally, the higher the MCS (index) is, the higher the throughput rate is.

According to some embodiments, the MCS allocation information obtained from the network device may indicate a first MCS for the first slot and a second MCS for the second slot, and the first MCS is less than the second MCS. In other words, compared with the second MCS, the first MCS for voice transmission is a conservative MCS. Meanwhile, compared with the first MCS, the second MCS is an aggressive MCS.

According to some embodiments, first MCS may be differently configured for different first slots. For example, the first slot in first CDRX period may be allocated with a first MCS of MCS index 15, while the first slot in second CDRX period may be allocated with a first MCS of MCS index 14. As another example, the first slot in each CDRX period may be allocated with a first MCS of MCS index 15. Note that although the first MCS for different first slots in different CDRX periods may be different, in each CDRX period, the first MCS for voice traffic is always less than the second MCS for the traffic other than voice.

According to some embodiments of the present disclosure, a conservative MCS (i.e., the first MCS) can be applied for voice traffic in the first slot. In this way, voice traffic can be communicated through a conservative MCS, which reduces voice packet loss and/or fast fading and improves voice quality.

In some embodiments, the method 200 may further include: obtaining, from the network device, a MCS allocation information, wherein the MCS allocation information indicates a first MCS for the first slot and a second MCS for the second slot, and wherein the first MCS is smaller than the second MCS, wherein communicating the traffic other than voice in the second slot further includes: communicating the traffic other than voice in the second slot based on the second MCS.

According to some embodiments of the present disclosure, a conservative MCS (i.e., the first MCS) can be applied for voice traffic in the first slot and an aggressive MCS (i.e., the second MCS) can be applied for other traffic in the second slot, which reduces voice packet loss and/or fast fading and preserves the throughout rate for traffic other than voice at the same time.

According to some embodiments, both the conservative rank and the conservative MCS can be applied for voice traffic in the first slot, which further reduces voice packet loss and/or fast fading and improves voice quality. According to some embodiments, both the aggressive rank and the aggressive MCS can be applied for traffic other than voice in the second slot, which preserves the throughout rate for traffic other than voice.

In some embodiments, the method 200 may further include: generating a sounding reference signal (SRS) channel estimation for transmission to the network device; and obtaining, from the network device, a first precoder corresponding to the first rank, wherein the first precoder is calculated by the network device based on the SRS channel estimation.

According to some embodiments, the network device allocates different ranks for the first slot and the second slot, and the network device may determine different precoding for the first slot and the second slot.

According to some embodiments, antenna selection is supported, and the UE may provide SRS channel estimation indicating the precoder directly to the network device.

According to some embodiments, supporting antenna selection means both the UE and the network device support antenna selection. According to some embodiments, supporting antenna selection includes supporting 1T2R, 1T4R, 2T4R, . . . , etc., where T represents transmitter and R represents receiver.

According to some embodiments of the present disclosure, by providing SRS channel estimation, the first precoder for voice traffic and a second precoder for other traffic with different ranks could be both calculated by the network device.

In some embodiments, the method 200 may further include: generating a precoding matrix indicator (PMI) for transmission to the network device; and obtaining, from the network device, a first precoder corresponding to the first rank, wherein the first precoder is determined by the network device based on the PMI and the first rank.

According to some embodiments, antenna selection is not supported, and the UE may provide a PMI and obtain a precoder determined by the network device based on the PMI and the first rank. According to some embodiments, not supporting antenna selection means at least one of the UE and the network device does not support antenna selection. For example, the UE supports antenna selection, but the network device does not support antenna selection, or the network device supports antenna selection, but the UE does not support antenna selection, or neither the UE nor the network device supports antenna selection. According to some embodiments, supporting antenna selection includes including 1T2R, 1T4R, 2T4R, . . . , etc., where T represents transmitter and R represents receiver.

According to some embodiments, antenna selection is not supported, and the UE may provide one PMI to the network device. According to some embodiments, the UE may provide the one PMI corresponding to the second rank to the network device and may obtain the second precoder corresponding to the second rank based on the one PMI of UE. According to some embodiments, the first precoder may not be determined directly by the one PMI of UE as the PMI corresponds to the second rank, but it may be determined by this PMI of UE and the first rank. The specific determination will be explained as follows.

According to some embodiments, the first precoder may be determined based on a selection of a portion of the PMI of UE and which portion from the PMI of UE should be selected may be determined based on the first rank. According to some embodiments, the selection of a portion of the PMI of UE may be based on codebook for different layers of CSI reporting. For example, the above-mentioned codebook may be determined based on the following Table 1 (Table 5.2.2.2.1-7 of TS 38.214) or Table 2 (Table 5.2.2.2.1-8 of TS 38.214).

According to some embodiments, the first rank includes 1 layer, and the second rank includes 3 layers. Referencing to Table 1 (see below), the network device may select a first beam from UE's PMI (v_{l,m}) and may execute co-phasing across polarized antenna array (φₙ) For example, the first beam may refer to the first column of matrix W_{l,l′,m,m′,n}⁽³⁾. However, the present disclosure does not limit to this, and the first beam may also refer to the second or the third column of matrix W_{l,l′,m,m′,n}⁽³⁾.

According to some embodiments, the first rank includes 2 layers, and the second rank includes 3 layers. Referencing to Table 1 (see below), the network device may select two (orthogonal) beams from UE's PMI (v_{l,m}) and may execute co-phasing across polarized antenna array (φₙ). For example, the selected two beams may refer to the first column and the second column of matrix W_{l,l′,m,m′,n}⁽³⁾. However, the present disclosure does not limit to this, and the selected two beams may also refer to the second column and the third column of matrix W_{l,l′,m,m′,n}⁽³⁾ or the first column and the third column of matrix W_{l,l′,m,m′,n}⁽³⁾.

TABLE 1
Table 5.2.2.2.1-7: Codebook for 3-layer CSI reporting using antenna ports 3000 to 2999 + P_{CSI-RS}
codebookMode = 1-2, P_{CSI-RS} < 16

| i_{1,1} | i_{1,2} | i₂ | |
|---|---|---|---|
| 0, . . . , N₁O₁ − 1 | 0, 1, . . . , N₂O₂ − 1 | 0, 1 | Wᵢ_{_{1,1}}_{,i}_{_{1,1}}₊ₖ_{₁}_{,i}_{_{1,2}}_{,i}_{_{1,2}}₊ₖ_{₂}_{,i}_{₂}⁽³⁾ |

where
${W}_{l , {l}^{′} , m , {m}^{′} , n}^{( 3 )} = \frac{1}{\sqrt{3 {P}_{CSI - RS}}} [ \begin{matrix}{v}_{l , m} & {v}_{{l}^{′} , {m}^{′}} & {v}_{l , m} \\ {φ}_{n} {v}_{l , m} & {φ}_{n} {v}_{{l}^{′} , {m}^{′}} & - {φ}_{n} {v}_{l , m}\end{matrix} ] .$
and the mapping from i_{1,3} to k₁ and k₂ is given in Table 5.2.2.2.1-4.

According to some embodiments, the first rank includes 1 layer, and the second rank includes 4 layers. Referencing to Table 2 (see below), the network device could select a first beam from UE's PMI (v_{l′,m}) and may execute co-phasing across polarized antenna array (φₙ). For example, the first beam may refer to the first column of matrix W_{l,l′,m,m′,n}⁽⁴⁾. However, the present disclosure does not limit to this, and the first beam may also refer to one of the second column, the third column and the fourth column among the four columns of matrix W_{l,l′,m,m′,n}⁽⁴⁾.

According to some embodiments, the first rank includes 2 layers, and the second rank includes 4 layers. Referencing to Table 2 (see below), the network device could select two (orthogonal) beams from UE's PMI (v_{l′,m}) and may execute co-phasing across polarized antenna array (φₙ). For example, the selected two beams may refer to the first column and the second column of matrix. However, the present disclosure does not limit to this, the selected two beams may refer to any two columns from the four columns of matrix W_{l,l′,m,m′,n}⁽⁴⁾.

TABLE 2
Table 5.2.2.2.1-8: Codebook for 4-layer CSI reporting using antenna ports 3000 to 2999 + P_{CSI-RS}
codebookMode = 1-2, P_{CSI-RS} < 16

| i_{1,1} | i_{1,2} | i₂ | |
|---|---|---|---|
| 0, . . . , N₁O₁ − 1 | 0, 1, . . . , N₂O₂ − 1 | 0, 1 | Wᵢ_{_{1,1}}_{,i}_{_{1,1}}₊ₖ_{₁}_{,i}_{_{1,2}}_{,i}_{_{1,2}}₊ₖ_{₂}_{,i}_{₂}⁽⁴⁾ |

where
${W}_{l , {l}^{′} , m , {m}^{′} , n}^{( 4 )} = \frac{1}{\sqrt{4 {P}_{CSI - RS}}} [ \begin{matrix}{v}_{l , m} & {v}_{{l}^{′} , {m}^{′}} & {v}_{l , m} & {v}_{{l}^{′} , {m}^{′}} \\ {φ}_{n} {v}_{l , m} & {φ}_{n} {v}_{{l}^{′} , {m}^{′}} & - {φ}_{n} {v}_{l , m} & - {φ}_{n} {v}_{{l}^{′} , {m}^{′}}\end{matrix} ] .$
and the mapping from i_{1,3} to k₁ and k₂ is given in Table 5.2.2.2.1-4.

According to some embodiments of the present disclosure, by calculating the first precoder corresponding to the first rank based on the PMI of UE and the first rank through the network device, the UE could obtain different precoders for different ranks based on a single PMI of UE.

In some embodiments, the method 200 may further include: obtaining, from the network device, a first channel state information (CSI) report configuration for the voice traffic and a second CSI report configuration for the traffic other than voice, wherein the first CSI report configuration includes a restriction of rank indication (RI); and generating a first RI for the voice traffic and a second RI for the traffic other than voice for transmission to the network device, wherein the first RI is determined based on the restriction of RI, and wherein the first rank is determined by the network device based on the first RI.

According to some embodiments, the network device may require the UE to report a conservative rank for voice traffic by applying a restriction of rank indication (RI). According to some embodiments, the restriction of RI may mask a high rank that is larger than the restriction of RI.

According to some embodiments, the restriction of rank indication (RI) may be 1 layer or 2 layers. However, the present disclosure does not limit to this. According to some embodiments, the restriction of RI could be any suitable positive integer layers. According to some embodiments, the first RI is determined based on the restriction of RI, which means the first RI may not exceed the restriction of RI. For example, the network device configures a restriction of RI with 2 layers of rank. In this case, although the UE may wish to report 3 layers of rank (e.g., according to best spectrum efficiency), the UE cannot report the 3 layers of rank for voice traffic to the network device due the restriction of RI. Note that the restriction of RI may only be used for voice traffic which does not affect the traffic other than voice. For example, the UE may wish to report 3 layers of rank and the UE is able to report the 3 layers of rank for the traffic other than voice due to the restriction of RI is specific to voice traffic.

According to some embodiments, the first rank is determined by the network device based on the first RI, and in this case the first rank does not exceed the first RI.

According to some embodiments, the network device may configure a special report configuration to UE for voice, with specific restriction of RI to mask high rank. According to some embodiments, this report period is either according to the voice slot period, or aperiodically triggered by network. According to some embodiments, the report frequency configuration could be either wideband, or subband (to execute frequency selective scheduling).

According to some embodiments, the UE may report the first RI to the network device via voice specific report ID. According to some embodiments, the UE may also report precoding matrix indicator (PMI) and/or channel quality indicator (CQI) result to the network device via voice specific report ID. According to some embodiments, the voice specific report ID may be allocated by the network device through the CSI report configuration specific to voice.

According to some embodiments, by obtaining a CSI report configuration specific to voice indicating a restriction of RI for voice traffic, the UE can only report the RI according to this restriction, obtain a conservative rank according to the reported RI, and communicate voice traffic under the conservative rank, thereby reducing voice packet loss and/or fast fading and improving voice quality.

According to some embodiments of the present disclosure, by limiting the RI reported by the UE, the first rank allocated for voice traffic could be a conservative rank, which reduces the voice packet loss and improves voice quality.

In some embodiments, the voice traffic may be transmitted on one or more component carrier (CC) of a plurality of CCs in carrier aggregation (CA), and wherein the one or more CCs for communicating the voice traffic may be dynamically switched based on a trigger event.

According to some embodiments, dynamically switching the one or more CCs for communicating the voice traffic may include dynamically switching from a primary carrier component (PCC) to a secondary carrier component (SCC), from a SCC to a PCC, from a PCC to both of PCC and SCC, from a SCC to both of PCC and SCC, . . . , etc. However, the present disclosure does not limit to this. For example, there may be one or more SCCs for communicating the voice traffic, and dynamically switching the one or more CCs for communicating the voice traffic may include dynamically switching from one SCC to another SCC, etc.

According to some embodiments, the trigger event may include a network device detected trigger event or a UE reported trigger event.

According to some embodiment, the network device detected trigger event may include the network device detecting that the voice packet loss is higher than a threshold. For example, if the voice packet loss is higher than a threshold, the one or more CCs for communicating the voice traffic may be dynamically switched. If the voice packet loss is not higher than a threshold, the voice traffic may be kept communicating through the one or more CCs.

According to some embodiment, the UE reported trigger event may include the UE reporting that the SRS signal to interference plus noise ratio (SINR) is less than a threshold. For example, if the SRS SINR is less than a threshold, the one or more CCs for communicating the voice traffic may be dynamically switched. If the SRS SINR is not less than a threshold, the voice traffic may be kept communicating through the one or more CCs.

According to some embodiments, the UE reported trigger event may include the UE reporting that the channel quality indication (CQI)/rank indication (RI) is less than a threshold. For example, if the CQI/RI is less than a threshold, the one or more CCs for communicating the voice traffic may be dynamically switched. If the CQI/RI is not less than a threshold, the voice traffic may be kept communicating through the one or more CCs.

According to some embodiments of the present disclosure, different CCs could be used for voice traffic to obtain diversity gain, thereby improving voice quality.

In some embodiments, an apparatus for a user equipment (UE) may include one or more processors configured to perform any of steps of the above methods according to the present disclosure.

In some embodiments, a computer readable medium may have computer programs stored thereon which, when executed by one or more processors, cause an apparatus to perform any of steps of the above methods according to the present disclosure.

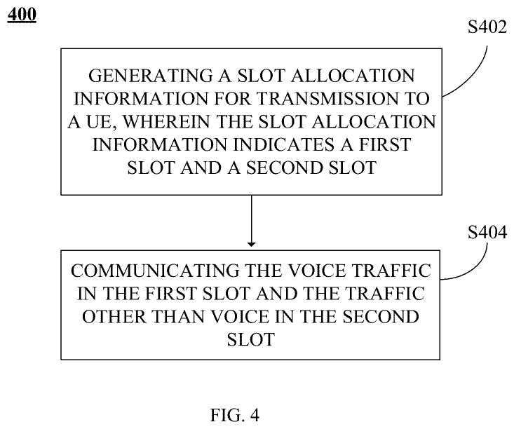

FIG. 4 illustrates a flowchart for an exemplary method for a network device in accordance with some embodiments. The method 400 illustrated in FIG. 4 may be implemented by the base station 150 described in FIG. 1. For example, the network device may be the network device of the base station 150.

In some embodiments, the method 400 for a network device may include the following steps: S402, generating a slot allocation information for transmission to a user equipment (UE), wherein the slot allocation information indicates a first slot and a second slot, and wherein the first slot is configured to communicate voice traffic and the second slot is configured to communicate traffic other than voice; and S404, communicating the voice traffic in the first slot and the traffic other than voice in the second slot.

According to some embodiments of the present disclosure, by generating a slot allocation information for transmission to the UE indicating a first slot for voice traffic and a second slot for other traffic, to the network device can communicate the voice traffic and the traffic other than voice in different slots with the UE. Accordingly, the voice traffic and the traffic other than voice can be configured respectively, which enables further configuration of one or more parameters of different slots, thereby achieving dynamic resource allocation to improve voice quality.

In the following, each step of the method 400 will be described. Note that those elements, expressions, features etc. that have already been described with reference to FIGS. 2, 3A and 3B and its corresponding description (about UE) are omitted herein for clarity.

At step S402, the network device generates a slot allocation information for transmission to a user equipment (UE), wherein the slot allocation information indicates a first slot and a second slot, and wherein the first slot is configured to communicate voice traffic and the second slot is configured to communicate traffic other than voice.

At step S404, the network device communicates the voice traffic in the first slot and the traffic other than voice in the second slot.

In some embodiments, the method 400 may further include: generating a rank allocation information for transmission to the UE, wherein the rank allocation information indicates a first rank for the first slot and a second rank for the second slot, and wherein the first rank is smaller than the second rank; and generating a modulation and coding scheme (MCS) allocation information for transmission to the UE, wherein the MCS allocation information indicates a first MCS for the first slot and a second MCS for the second slot, and wherein the first MCS is smaller than the second MCS, wherein communicating the voice traffic in the first slot further includes: communicating the voice traffic in the first slot based on the first rank and the first MCS.

According to some embodiments of the present disclosure, both the conservative rank and the conservative MCS can be applied for voice traffic in the first slot, which further reduces voice packet loss and/or fast fading and improves voice quality. According to some embodiments, both the aggressive rank and the aggressive MCS can be applied for traffic other than voice in the second slot, which preserves the throughout rate for traffic other than voice.

In some embodiments, the method 400 may further include: obtaining, from the UE, a channel quality information, wherein generating the rank allocation information further includes: determining the second rank based on the channel quality information; and determining the first rank based on the second rank and a restriction of the second rank such that the first rank is smaller than the second rank.

According to some embodiments, the second rank is determined based on the channel quality information and then the first rank is determined based on the second rank. According to some embodiments, the restriction of the second rank is determined by the network device based on a predetermined criterion. According to some embodiments, the predetermined criterion may be at least one of: an actual situation of channel quality, the parameters of the UE and/or the network device, a fixed number of layers, or any suitable criterion.

According to some embodiments of the present disclosure, by obtaining a smaller rank for voice traffic compared with other traffic, the voice traffic may be communicated under a conservative rank, thereby reducing voice packet loss and/or fast fading and improving voice quality.

In some embodiments, the method 400 may further include: generating a first channel state information (CSI) report configuration for the voice traffic and a second CSI report configuration for the traffic other than voice for transmission to the UE, wherein the first CSI report configuration includes a restriction of rank indication (RI); and obtaining, from the UE, a first RI for the voice traffic and a second RI for the traffic other than voice, wherein the first RI is determined by the UE based on the restriction of RI, wherein generating the rank allocation information further includes: determining the first rank based on the first RI.

According to some embodiments of the present disclosure, by limiting the RI reported by the UE, the first rank allocated for voice traffic could be a conservative rank, which reduces the voice packet loss and improves voice quality.

In some embodiments, the method 400 may further include: in accordance with a determination that an antenna selection is supported, obtaining, from the UE, a sounding reference signal (SRS) channel estimation; and generating a first precoder corresponding to the first rank for transmission to the UE based on the SRS channel estimation.

According to some embodiments of the present disclosure, by obtaining SRS channel estimation, the precoder for voice traffic and the precoder for other traffic with different ranks could be both calculated by the network device.

In some embodiments, the method 400 may further include: in accordance with a determination that an antenna selection is not supported, obtaining, from the UE, a precoding matrix indicator (PMI); and generating a first precoder corresponding to the first rank for transmission to the UE based on the PMI and the first rank.

According to some embodiments of the present disclosure, by calculating the first precoder corresponding to the first rank based on the PMI of UE and the first rank through the network device, the network device could provide different precoders for different ranks to the UE based on a single PMI of UE.

In some embodiments, the first rank includes a predetermined number of layers, and wherein generating the first precoder corresponding to the first rank further includes: select the predetermined number of beams from the PMI.

According to some embodiments of the present disclosure, by calculating the first precoder corresponding to the first rank based on the PMI of UE and the first rank through the network device, the UE could obtain different precoders for different ranks based on a single PMI of UE.

In some embodiments, an apparatus for a network device may include one or more processors configured to perform any of steps of the above methods according to the present disclosure.

In some embodiments, a computer readable medium may have computer programs stored thereon which, when executed by one or more processors, cause an apparatus to perform any of steps of the above methods according to the present disclosure.

In some embodiments, a computer program product including computer programs which, when executed by one or more processors, cause an apparatus to perform steps of: obtaining, from a network device, a slot allocation information, wherein the slot allocation information indicates a first slot and a second slot, and wherein the first slot is configured to communicate voice traffic and the second slot is configured to communicate traffic other than voice; and communicating the voice traffic in the first slot and communicating the traffic other than voice in the second slot.

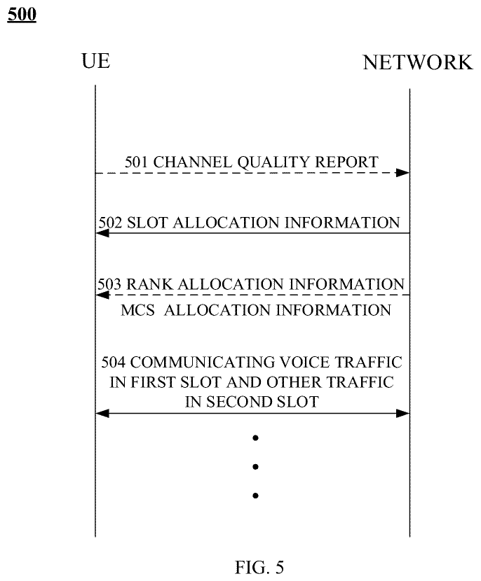

FIG. 5 illustrates a flowchart for exemplary steps for dynamic resource allocation in accordance with some embodiments.

In FIG. 5, the steps of the method for UE and the method for network device to realize dynamic resource allocation according to some embodiments are shown. Note that those steps represented by full line arrow are basic steps (e.g., Step 502 and Step 504) while those steps represented by dotted line arrow are additional steps (e.g., Step 501 and Step 503). In the following, basic steps Step 502 and Step 504 will be discussed first, and additional steps Step 501 and Step 503 will be discussed later.

At Step 502, the network device may transmit a slot allocation information to the UE, wherein the slot allocation information indicates a first slot and a second slot, and wherein the first slot is configured to communicate voice traffic and the second slot is configured to communicate traffic other than voice. Step 502 can be implemented according to the description with reference to Step S202 and/or Step S402.

At Step 504, the UE and the network device may communicate (e.g., transmit and/or receive) the voice traffic in the first slot and the traffic other than voice in the second slot based on the slot allocation information. Step 504 can be implemented according to the description with reference to Step S204 and/or Step S404.

At Step 501, the UE may transmit channel quality report to the network device, wherein the channel quality report indicates the quality of channel. According to some embodiments, the slot allocation information transmitted by the network device may be determined by the channel quality report transmitted by the UE. However, the present disclosure does not limit to this. According to some embodiments, the slot allocation information transmitted by the network device may not be determined by the channel quality report transmitted by the UE.

At Step 503, the network device may transmit a rank allocation information and a MCS allocation information to the UE, wherein the rank allocation information indicates a first rank for the first slot and a second rank for the second slot, and wherein the first rank is less than the second rank, and wherein the MCS allocation information indicates a first MCS for the first slot and a second MCS for the second slot, and wherein the first MCS is smaller than the second MCS. According to some embodiments, the UE and the network device may communicate (e.g., transmit and/or receive) the voice traffic in the first slot and the traffic other than voice in the second slot based on the slot allocation information and at least one of the rank allocation information and the MCS allocation information. However, the present disclosure does not limit to this. According to some embodiments, the UE and the network device may communicate (e.g., transmit and/or receive) the voice traffic in the first slot and the traffic other than voice in the second slot without considering either the rank allocation information or the MCS allocation information.

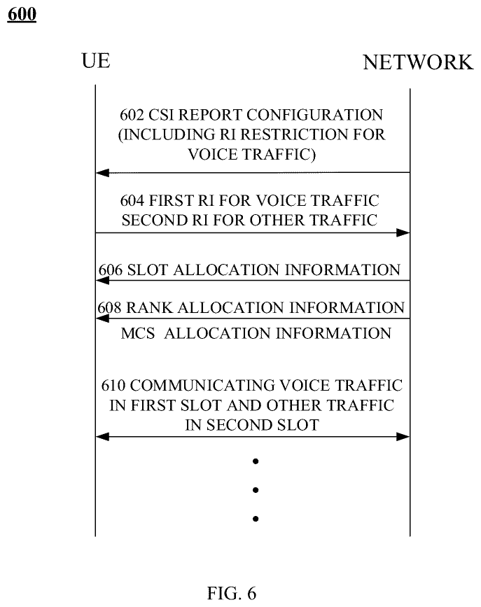

FIG. 6 illustrates another flowchart for exemplary steps for dynamic resource allocation in accordance with some embodiments.

In FIG. 6, the steps of the method for UE and the method for network device to realize dynamic resource allocation according to some embodiments are shown. In some embodiments shown by FIG. 6, the report of UE for voice traffic may be restricted.

At Step 602, the network device may transmit a first channel state information (CSI) report configuration for the voice traffic and a second CSI report configuration for the traffic other than voice, wherein the first CSI report configuration includes a restriction of rank indication (RI).

At Step 604, the UE may transmit a first RI for the voice traffic and a second RI for the traffic other than voice for transmission to the network device, wherein the first RI is determined based on the restriction of RI.

At Step 606, the network device may determine the first rank based on the first RI. The network device may transmit a slot allocation information to the UE, wherein the slot allocation information indicates a first slot and a second slot, and wherein the first slot is configured to communicate voice traffic and the second slot is configured to communicate traffic other than voice. Step 606 can be implemented according to the description with reference to Step S202 and/or Step S402.

At Step 608, the network device may transmit a rank allocation information and a MCS allocation information to the UE, wherein the rank allocation information indicates a first rank for the first slot and a second rank for the second slot, and wherein the first rank is smaller than the second rank, and wherein the MCS allocation information indicates a first MCS for the first slot and a second MCS for the second slot, and wherein the first MCS is less than the second MCS. According to some embodiments, the rank allocation information may be determined based on the first RI for voice traffic and the second RI for other traffic transmitted by the UE in Step 604.

At Step 610, the UE and the network device may communicate the voice traffic in the first slot and the traffic other than voice in the second slot. Step 610 can be implemented according to the description with reference to Step S204 and/or Step S404. According to some embodiments, the UE and the network device may communicate (e.g., transmit and/or receive) the voice traffic in the first slot and the traffic other than voice in the second slot based on the slot allocation information and at least one of the rank allocation information and the MCS allocation information.

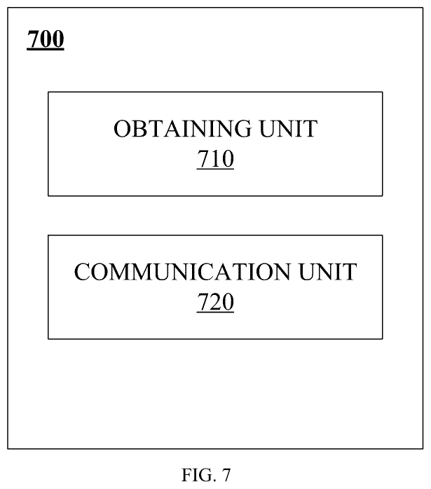

FIG. 7 illustrates an exemplary block diagram of an apparatus for a UE in accordance with some embodiments. The apparatus 700 illustrated in FIG. 7 may be used to implement the method 200 as illustrated in combination with FIG. 2.

As illustrated in FIG. 7, the apparatus 700 includes an obtaining unit 710 and a communication unit 720.

The obtaining unit 710 may be configured to obtain, from a network device, a slot allocation information, wherein the slot allocation information indicates a first slot and a second slot, and wherein the first slot is configured to communicate voice traffic and the second slot is configured to communicate traffic other than voice.

The communication unit 720 may be configured to communicate the voice traffic in the first slot and the traffic other than voice in the second slot.

According to some embodiments of the present disclosure, by obtaining a slot allocation information indicating a first slot and a second slot from a network device, a UE can be configured to communicate the voice traffic in the first slot and the traffic other than voice in the second slot. Accordingly, the voice traffic and the traffic other than voice can be configured respectively using corresponding slot, thereby achieving dynamic resource allocation to improve voice quality.

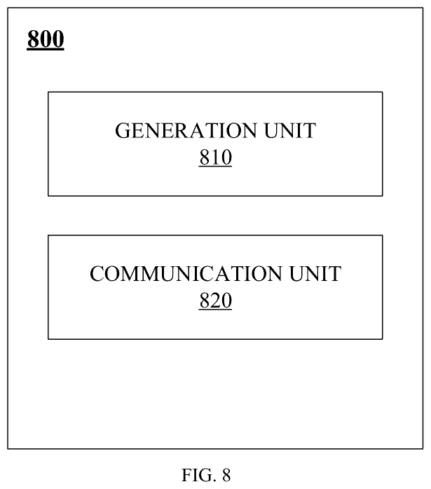

FIG. 8 illustrates an exemplary block diagram of an apparatus for a network device in accordance with some embodiments. The apparatus 800 illustrated in FIG. 4 may be used to implement the method 400 as illustrated in combination with FIG. 4.

As illustrated in FIG. 8, the apparatus 800 includes a generation unit 810 and a communication unit 820.

The generation unit 810 may be configured to generate a slot allocation information for transmission to a user equipment (UE), wherein the slot allocation information indicates a first slot and a second slot, and wherein the first slot is configured to communicate voice traffic and the second slot is configured to communicate traffic other than voice.

The communication unit 820 may be configured to generate communicate the voice traffic in the first slot and the traffic other than voice in the second slot.

According to some embodiments of the present disclosure, by generating a slot allocation information for transmission to a user equipment (UE) indicating a first slot and a second slot, a UE can be configured to communicate the voice traffic in the first slot and the traffic other than voice in the second slot. Accordingly, the voice traffic and the traffic other than voice can be configured respectively using corresponding slot, thereby achieving dynamic resource allocation to improve voice quality.

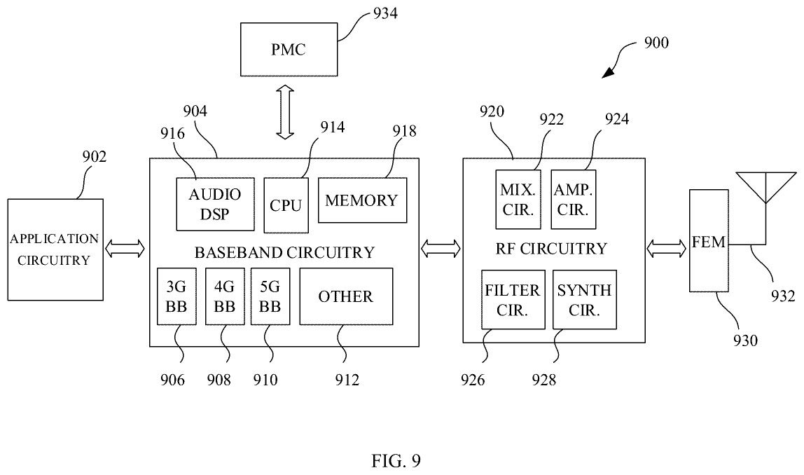

FIG. 9 illustrates example components of a device 900 in accordance with some embodiments. In some embodiments, the device 900 may include application circuitry 902, baseband circuitry 904, Radio Frequency (RF) circuitry (shown as RF circuitry 920), front-end module (FEM) circuitry (shown as FEM circuitry 930), one or more antennas 932, and power management circuitry (PMC) (shown as PMC 934) coupled together at least as shown. The components of the illustrated device 900 may be included in a UE or a RAN node. In some embodiments, the device 900 may include fewer elements (e.g., a RAN node may not utilize application circuitry 902, and instead include a processor/controller to process IP data received from an EPC). In some embodiments, the device 900 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 902 may include one or more application processors. For example, the application circuitry 902 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 900. In some embodiments, processors of application circuitry 902 may process IP data packets received from an EPC.

The baseband circuitry 904 may include circuitry such as, but not limited to, one or more single-core or multi-core processors. The baseband circuitry 904 may include one or more baseband processors or control logic to process baseband signals received from a receive signal path of the RF circuitry 920 and to generate baseband signals for a transmit signal path of the RF circuitry 920. The baseband circuitry 904 may interface with the application circuitry 902 for generation and processing of the baseband signals and for controlling operations of the RF circuitry 920. For example, in some embodiments, the baseband circuitry 904 may include a third generation (3G) baseband processor (3G baseband processor 906), a fourth generation (4G) baseband processor (4G baseband processor 908), a fifth generation (5G) baseband processor (5G baseband processor 910), or other baseband processor(s) 912 for other existing generations, generations in development or to be developed in the future (e.g., second generation (2G), sixth generation (6G), etc.). The baseband circuitry 904 (e.g., one or more of baseband processors) may handle various radio control functions that enable communication with one or more radio networks via the RF circuitry 920. In other embodiments, some or all of the functionality of the illustrated baseband processors may be included in modules stored in the memory 918 and executed via a Central Processing ETnit (CPET 914). The radio control functions may include, but are not limited to, signal modulation/demodulation, encoding/decoding, radio frequency shifting, etc. In some embodiments, modulation/demodulation circuitry of the baseband circuitry 904 may include Fast-Fourier Transform (FFT), precoding, or constellation mapping/demapping functionality. In some embodiments, encoding/decoding circuitry of the baseband circuitry 904 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 904 may include a digital signal processor (DSP), such as one or more audio DSP(s) 916. The one or more audio DSP(s) 916 may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 904 and the application circuitry 902 may be implemented together such as, for example, on a system on a chip (SOC).

In some embodiments, the baseband circuitry 904 may provide for communication compatible with one or more radio technologies. For example, in some embodiments, the baseband circuitry 904 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 904 is configured to support radio communications of more than one wireless protocol may be referred to as multi-mode baseband circuitry.

The RF circuitry 920 may enable communication with wireless networks using modulated electromagnetic radiation through a non-solid medium. In various embodiments, the RF circuitry 920 may include switches, filters, amplifiers, etc. to facilitate the communication with the wireless network. The RF circuitry 920 may include a receive signal path which may include circuitry to down-convert RF signals received from the FEM circuitry 930 and provide baseband signals to the baseband circuitry 904. The RF circuitry 920 may also include a transmit signal path which may include circuitry to up-convert baseband signals provided by the baseband circuitry 904 and provide RF output signals to the FEM circuitry 930 for transmission.

In some embodiments, the receive signal path of the RF circuitry 920 may include mixer circuitry 922, amplifier circuitry 924 and filter circuitry 926. In some embodiments, the transmit signal path of the RF circuitry 920 may include filter circuitry 926 and mixer circuitry 922. The RF circuitry 920 may also include synthesizer circuitry 928 for synthesizing a frequency for use by the mixer circuitry 922 of the receive signal path and the transmit signal path. In some embodiments, the mixer circuitry 922 of the receive signal path may be configured to down-convert RF signals received from the FEM circuitry 930 based on the synthesized frequency provided by synthesizer circuitry 928. The amplifier circuitry 924 may be configured to amplify the down-converted signals and the filter circuitry 926 may be a low-pass filter (LPF) or band-pass filter (BPF) configured to remove unwanted signals from the down-converted signals to generate output baseband signals. Output baseband signals may be provided to the baseband circuitry 904 for further processing. In some embodiments, the output baseband signals may be zero-frequency baseband signals, although this is not a requirement. In some embodiments, the mixer circuitry 922 of the receive signal path may include passive mixers, although the scope of the embodiments is not limited in this respect.

In some embodiments, the mixer circuitry 922 of the transmit signal path may be configured to up-convert input baseband signals based on the synthesized frequency provided by the synthesizer circuitry 928 to generate RF output signals for the FEM circuitry 930. The baseband signals may be provided by the baseband circuitry 904 and may be filtered by the filter circuitry 926.

In some embodiments, the mixer circuitry 922 of the receive signal path and the mixer circuitry 922 of the transmit signal path may include two or more mixers and may be arranged for quadrature downconversion and upconversion, respectively. In some embodiments, the mixer circuitry 922 of the receive signal path and the mixer circuitry 922 of the transmit signal path may include two or more mixers and may be arranged for image rejection (e.g., Hartley image rejection). In some embodiments, the mixer circuitry 922 of the receive signal path and the mixer circuitry 922 may be arranged for direct downconversion and direct upconversion, respectively. In some embodiments, the mixer circuitry 922 of the receive signal path and the mixer circuitry 922 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 920 may include analog-to-digital converter (ADC) and digital-to-analog converter (DAC) circuitry and the baseband circuitry 904 may include a digital baseband interface to communicate with the RF circuitry 920.

In some dual-mode embodiments, a separate radio IC circuitry may be provided for processing signals for each spectrum, although the scope of the embodiments is not limited in this respect.

In some embodiments, the synthesizer circuitry 928 may be a fractional −N synthesizer or a fractional N/N+1 synthesizer, although the scope of the embodiments is not limited in this respect as other types of frequency synthesizers may be suitable. For example, synthesizer circuitry 928 may be a delta-sigma synthesizer, a frequency multiplier, or a synthesizer including a phase-locked loop with a frequency divider.

The synthesizer circuitry 928 may be configured to synthesize an output frequency for use by the mixer circuitry 922 of the RF circuitry 920 based on a frequency input and a divider control input. In some embodiments, the synthesizer circuitry 928 may be a fractional N/N+1 synthesizer.

In some embodiments, frequency input may be provided by a voltage controlled oscillator (VCO), although that is not a requirement. Divider control input may be provided by either the baseband circuitry 904 or the application circuitry 902 (such as an applications processor) depending on the desired output frequency. In some embodiments, a divider control input (e.g., N) may be determined from a look-up table based on a channel indicated by the application circuitry 902.

Synthesizer circuitry 928 of the RF circuitry 920 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 928 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 920 may include an IQ/polar converter.

The FEM circuitry 930 may include a receive signal path which may include circuitry configured to operate on RF signals received from one or more antennas 932, amplify the received signals and provide the amplified versions of the received signals to the RF circuitry 920 for further processing. The FEM circuitry 930 may also include a transmit signal path which may include circuitry configured to amplify signals for transmission provided by the RF circuitry 920 for transmission by one or more of the one or more antennas 932. In various embodiments, the amplification through the transmit or receive signal paths may be done solely in the RF circuitry 920, solely in the FEM circuitry 930, or in both the RF circuitry 920 and the FEM circuitry 930.

In some embodiments, the FEM circuitry 930 may include a TX/RX switch to switch between transmit mode and receive mode operation. The FEM circuitry 930 may include a receive signal path and a transmit signal path. The receive signal path of the FEM circuitry 930 may include an LNA to amplify received RF signals and provide the amplified received RF signals as an output (e.g., to the RF circuitry 920). The transmit signal path of the FEM circuitry 930 may include a power amplifier (PA) to amplify input RF signals (e.g., provided by the RF circuitry 920), and one or more filters to generate RF signals for subsequent transmission (e.g., by one or more of the one or more antennas 932).

In some embodiments, the PMC 934 may manage power provided to the baseband circuitry 904. In particular, the PMC 934 may control power-source selection, voltage scaling, battery charging, or DC-to-DC conversion. The PMC 934 may often be included when the device 900 is capable of being powered by a battery, for example, when the device 900 is included in an EGE. The PMC 934 may increase the power conversion efficiency while providing desirable implementation size and heat dissipation characteristics.

FIG. 9 shows the PMC 934 coupled only with the baseband circuitry 904. However, in other embodiments, the PMC 934 may be additionally or alternatively coupled with, and perform similar power management operations for, other components such as, but not limited to, the application circuitry 902, the RF circuitry 920, or the FEM circuitry 930.

In some embodiments, the PMC 934 may control, or otherwise be part of, various power saving mechanisms of the device 900. For example, if the device 900 is in an RRC Connected state, where it is still connected to the RAN node as it expects to receive traffic shortly, then it may enter a state known as Discontinuous Reception Mode (DRX) after a period of inactivity. During this state, the device 900 may power down for brief intervals of time and thus save power.

If there is no data traffic activity for an extended period of time, then the device 900 may transition off to an RRC Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 902 and processors of the baseband circuitry 904 may be used to execute elements of one or more instances of a protocol stack. For example, processors of the baseband circuitry 904, alone or in combination, may be used to execute Layer 3, Layer 2, or Layer 1 functionality, while processors of the application circuitry 902 may utilize data (e.g., packet data) received from these layers and further execute Layer 4 functionality (e.g., transmission communication protocol (TCP) and user datagram protocol (UDP) layers). As referred to herein, Layer 3 may include a radio resource control (RRC) layer, described in further detail below. As referred to herein, Layer 2 may include a medium access control (MAC) layer, a radio link control (RLC) layer, and a packet data convergence protocol (PDCP) layer, described in further detail below. As referred to herein, Layer 1 may include a physical (PHY) layer of a UE/RAN node, described in further detail below.

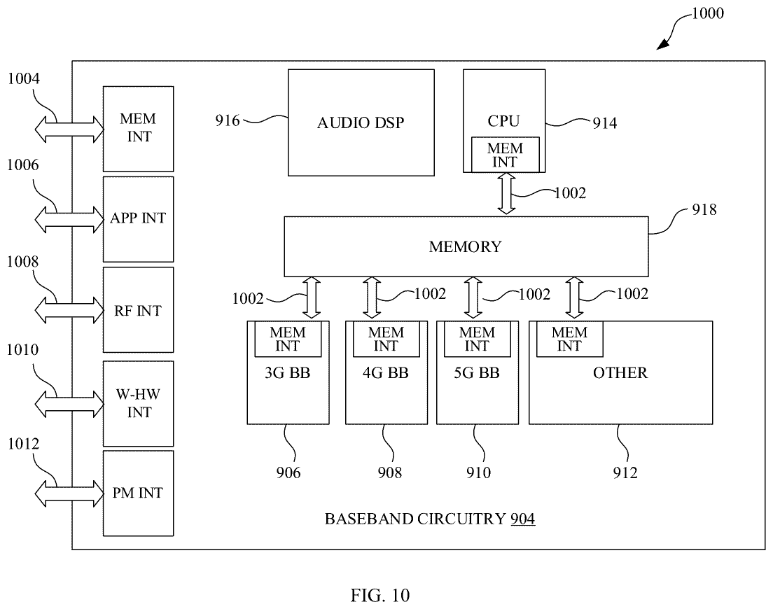

FIG. 10 illustrates example interfaces 1000 of baseband circuitry in accordance with some embodiments. As discussed above, the baseband circuitry 904 of FIG. 9 may include 3G baseband processor 906, 4G baseband processor 908, 5G baseband processor 910, other baseband processor(s) 912, CPU 914, and a memory 918 utilized by said processors. As illustrated, each of the processors may include a respective memory interface 1002 to send/receive data to/from the memory 918.

The baseband circuitry 904 may further include one or more interfaces to communicatively couple to other circuitries/devices, such as a memory interface 1004 (e.g., an interface to send/receive data to/from memory external to the baseband circuitry 904), an application circuitry interface 1006 (e.g., an interface to send/receive data to/from the application circuitry 902 of FIG. 9), an RF circuitry interface 1008 (e.g., an interface to send/receive data to/from RF circuitry 920 of FIG. 9), a wireless hardware connectivity interface 1010 (e.g., an interface to send/receive data to/from Near Field Communication (NFC) components, Bluetooth® components (e.g., Bluetooth® Low Energy), Wi-Fi® components, and other communication components), and a power management interface 1012 (e.g., an interface to send/receive power or control signals to/from the PMC 934.

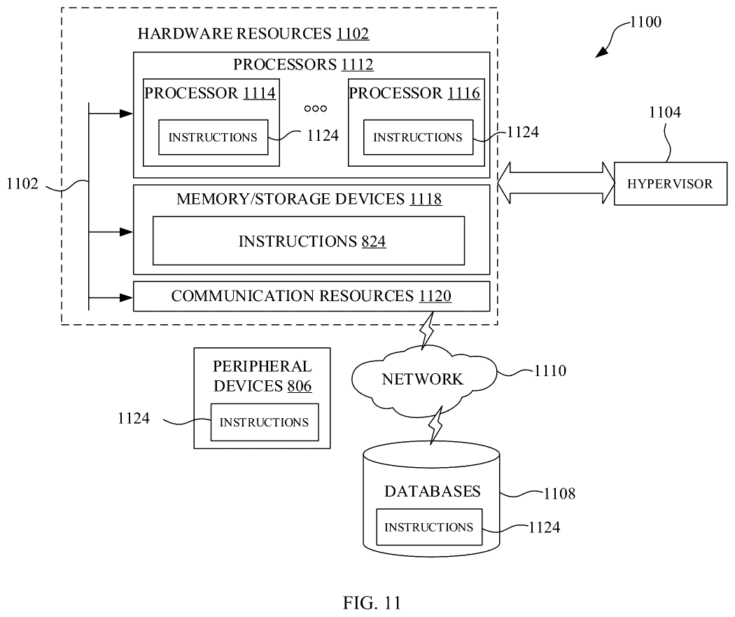

FIG. 11 is a block diagram illustrating components 1100, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1102 including one or more processors 1112 (or processor cores), one or more memory/storage devices 1118, and one or more communication resources 1120, each of which may be communicatively coupled via a bus 1122. For embodiments where node virtualization (e.g., NFV) is utilized, a hypervisor 1104 may be executed to provide an execution environment for one or more network slices/sub-slices to utilize the hardware resources 1102.

The processors 1112 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1114 and a processor 1116.

The memory/storage devices 1118 may include main memory, disk storage, or any suitable combination thereof. The memory/storage devices 1118 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1120 may include interconnection or network interface components or other suitable devices to communicate with one or more peripheral devices 1106 or one or more databases 1108 via a network 1110. For example, the communication resources 1120 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1124 may include software, a program, an application, an applet, an app, or other executable code for causing at least any of the processors 1112 to perform any one or more of the methodologies discussed herein. The instructions 1124 may reside, completely or partially, within at least one of the processors 1112 (e.g., within the processor's cache memory), the memory/storage devices 1118, or any suitable combination thereof. Furthermore, any portion of the instructions 1124 may be transferred to the hardware resources 1102 from any combination of the peripheral devices 1106 or the databases 1108. Accordingly, the memory of the processors 1112, the memory/storage devices 1118, the peripheral devices 1106, and the databases 1108 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

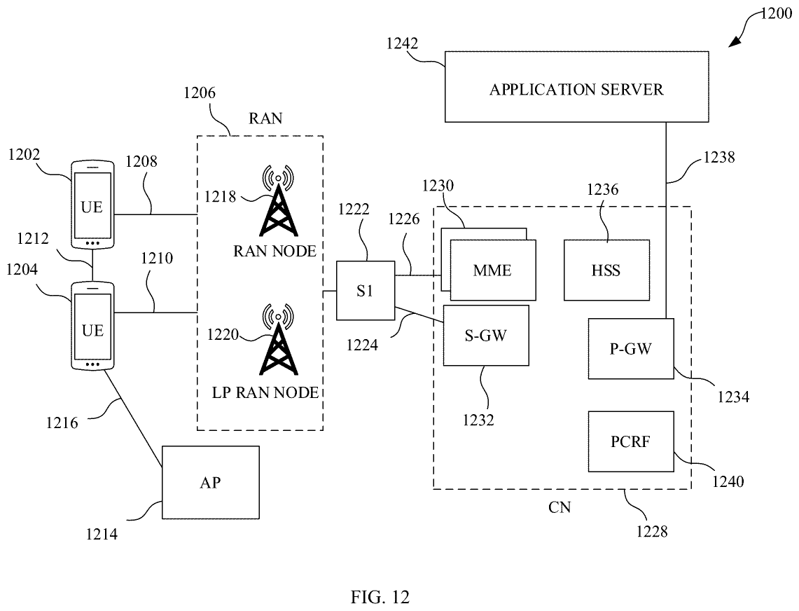

FIG. 12 illustrates an architecture of a system 1200 of a network in accordance with some embodiments. The system 1200 includes one or more user equipment (UE), shown in this example as a UE 1202 and a UE 1204. The UE 1202 and the UE 1204 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, or any computing device including a wireless communications interface.

In some embodiments, any of the UE 1202 and the UE 1204 can include an Internet of Things (IoT) UE, which can include a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UE 1202 and the UE 1204 may be configured to connect, e.g., communicatively couple, with a radio access network (RAN), shown as RAN 1206. The RAN 1206 may be, for example, an Evolved ETniversal Mobile Telecommunications System (ETMTS) Terrestrial Radio Access Network (E-UTRAN), a NextGen RAN (NG RAN), or some other type of RAN. The UE 1202 and the UE 1204 utilize connection 1208 and connection 1210, respectively, each of which includes a physical communications interface or layer (discussed in further detail below); in this example, the connection 1208 and the connection 1210 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 1202 and the UE 1204 may further directly exchange communication data via a ProSe interface 1212. The ProSe interface 1212 may alternatively be referred to as a sidelink interface including one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1204 is shown to be configured to access an access point (AP), shown as AP 1214, via connection 1216. The connection 1216 can include a local wireless connection, such as a connection consistent with any IEEE 802.11 protocol, wherein the AP 1214 would include a wireless fidelity (WiFi®) router. In this example, the AP 1214 may be connected to the Internet without connecting to the core network of the wireless system (described in further detail below).

The RAN 1206 can include one or more access nodes that enable the connection 1208 and the connection 1210. These access nodes (ANs) can be referred to as base stations (BSs), NodeBs, evolved NodeBs (eNBs), next Generation NodeBs (gNB), RAN nodes, and so forth, and can include ground stations (e.g., terrestrial access points) or satellite stations providing coverage within a geographic area (e.g., a cell). The RAN 1206 may include one or more RAN nodes for providing macrocells, e.g., macro RAN node 1218, and one or more RAN nodes for providing femtocells or picocells (e.g., cells having smaller coverage areas, smaller user capacity, or higher bandwidth compared to macrocells), e.g., a low power (LP) RAN node such as LP RAN node 1220.

Any of the macro RAN node 1218 and the LP RAN node 1220 can terminate the air interface protocol and can be the first point of contact for the UE 1202 and the UE 1204. In some embodiments, any of the macro RAN node 1218 and the LP RAN node 1220 can fulfill various logical functions for the RAN 1206 including, but not limited to, radio network controller (RNC) functions such as radio bearer management, uplink and downlink dynamic radio resource management and data packet scheduling, and mobility management.

In accordance with some embodiments, the EGE 1202 and the EGE 1204 can be configured to communicate using Orthogonal Frequency-Division Multiplexing (OFDM) communication signals with each other or with any of the macro RAN node 1218 and the LP RAN node 1220 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can include a plurality of orthogonal sub carriers.

In some embodiments, a downlink resource grid can be used for downlink transmissions from any of the macro RAN node 1218 and the LP RAN node 1220 to the UE 1202 and the UE 1204, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid includes a number of resource blocks, which describe the mapping of certain physical channels to resource elements. Each resource block includes a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1202 and the UE 1204. The physical downlink control channel (PDCCH) may carry information about the transport format and resource allocations related to the PDSCH channel, among other things. It may also inform the UE 1202 and the UE 1204 about the transport format, resource allocation, and H-ARQ (Hybrid Automatic Repeat Request) information related to the uplink shared channel. Typically, downlink scheduling (assigning control and shared channel resource blocks to the UE 1204 within a cell) may be performed at any of the macro RAN node 1218 and the LP RAN node 1220 based on channel quality information fed back from any of the UE 1202 and UE 1204. The downlink resource assignment information may be sent on the PDCCH used for (e.g., assigned to) each of the UE 1202 and the UE 1204.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 1206 is communicatively coupled to a core network (CN), shown as CN 1228—via an S1 interface 1222. In embodiments, the CN 1228 may be an evolved packet core (EPC) network, a NextGen Packet Core (NPC) network, or some other type of CN. In this embodiment the S1 interface 1222 is split into two parts: the S1-U interface 1224, which carries traffic data between the macro RAN node 1218 and the LP RAN node 1220 and a serving gateway (S-GW), shown as S-GW 1132, and an S1-mobility management entity (MME) interface, shown as S1-MME interface 1226, which is a signaling interface between the macro RAN node 1218 and LP RAN node 1220 and the MME(s) 1230.

In this embodiment, the CN 1228 includes the MME(s) 1230, the S-GW 1232, a Packet Data Network (PDN) Gateway (P-GW) (shown as P-GW 1234), and a home subscriber server (HSS) (shown as HSS 1236). The MME(s) 1230 may be similar in function to the control plane of legacy Serving General Packet Radio Service (GPRS) Support Nodes (SGSN). The MME(s) 1230 may manage mobility aspects in access such as gateway selection and tracking area list management. The HSS 1236 may include a database for network users, including subscription-related information to support the network entities' handling of communication sessions. The CN 1228 may include one or several HSS 1236, depending on the number of mobile subscribers, on the capacity of the equipment, on the organization of the network, etc. For example, the HSS 1236 can provide support for routing/roaming, authentication, authorization, naming/addressing resolution, location dependencies, etc.

The S-GW 1232 may terminate the S1 interface 1222 towards the RAN 1206, and routes data packets between the RAN 1206 and the CN 1228. In addition, the S-GW 1232 may be a local mobility anchor point for inter-RAN node handovers and also may provide an anchor for inter-3 GPP mobility. Other responsibilities may include lawful intercept, charging, and some policy enforcement.

The P-GW 1234 may terminate an SGi interface toward a PDN. The P-GW 1234 may route data packets between the CN 1228 (e.g., an EPC network) and external networks such as a network including the application server 1242 (alternatively referred to as application function (AF)) via an Internet Protocol (IP) interface (shown as IP communications interface 1238). Generally, an application server 1242 may be an element offering applications that use IP bearer resources with the core network (e.g., ETMTS Packet Services (PS) domain, LTE PS data services, etc.). In this embodiment, the P-GW 1234 is shown to be communicatively coupled to an application server 1242 via an IP communications interface 1238. The application server 1242 can also be configured to support one or more communication services (e.g., Voice-over-Internet Protocol (VoIP) sessions, PTT sessions, group communication sessions, social networking services, etc.) for the UE 1202 and the UE 1204 via the CN 1228.

The P-GW 1234 may further be a node for policy enforcement and charging data collection. A Policy and Charging Enforcement Function (PCRF) (shown as PCRF 1240) is the policy and charging control element of the CN 1228. In a non-roaming scenario, there may be a single PCRF in the Home Public Land Mobile Network (HPLMN) associated with a ETE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1240 may be communicatively coupled to the application server 1242 via the P-GW 1234. The application server 1242 may signal the PCRF 1240 to indicate a new service flow and select the appropriate Quality of Service (QoS) and charging parameters. The PCRF 1240 may provision this rule into a Policy and Charging Enforcement Function (PCEF) (not shown) with the appropriate traffic flow template (TFT) and QoS class of identifier (QCI), which commences the QoS and charging as specified by the application server 1242.

### Additional Examples

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.
Example 1 is a method for a user equipment (UE), including: obtaining a slot allocation information from a network device, wherein the slot allocation information indicates a first slot and a second slot, and wherein the first slot is configured to communicate voice traffic and the second slot is configured to communicate traffic other than voice; and communicating the voice traffic in the first slot and the traffic other than voice in the second slot.
Example 2 is the method of Example 1, further including: obtaining, from the network device, a rank allocation information, wherein the rank allocation information indicates a first rank for the first slot and a second rank for the second slot, and wherein the first rank is smaller than the second rank, wherein communicating the voice traffic in the first slot further includes: communicating the voice traffic in the first slot based on the first rank.
Example 3 is the method of Example 1, further including: obtaining, from the network device, a modulation and coding scheme (MCS) allocation information, wherein the MCS allocation information indicates a first MCS for the first slot and a second MCS for the second slot, and wherein the first MCS is less than the second MCS, wherein communicating the voice traffic in the first slot further includes: communicating the voice traffic in the first slot based on the first MCS.
Example 4 is the method of Example 1, wherein the first slot is a virtual slot and a cycle of the first slot is aligned with a connected mode discontinuous reception (CDRX) period.
Example 5 is the method of Example 2, further including: generating a sounding reference signal (SRS) channel estimation for transmission to the network device; and obtaining, from the network device, a first precoder corresponding to the first rank, wherein the first precoder is calculated by the network device based on the SRS channel estimation.
Example 6 is the method of Example 2, further including: generating a precoding matrix indicator (PMI) for transmission to the network device; and obtaining, from the network device, a first precoder corresponding to the first rank, wherein the first precoder is determined by the network device based on the PMI and the first rank.
Example 7 is the method of Example 2, further including: obtaining, from the network device, a first channel state information (CSI) report configuration for the voice traffic and a second CSI report configuration for the traffic other than voice, wherein the first CSI report configuration includes a restriction of rank indication (RI); and generating a first RI for the voice traffic and a second RI for the traffic other than voice for transmission to the network device, wherein the first RI is determined based on the restriction of RI, and wherein the first rank is determined by the network device based on the first RI.
Example 8 is the method of Example 1, wherein the voice traffic is transmitted on one or more component carrier (CC) of a plurality of CCs in carrier aggregation (CA), and wherein the one or more CCs for communicating the voice traffic are dynamically switched based on a trigger event.
Example 9 is an apparatus for a user equipment (UE), including one or more processors configured to perform steps of the method according to any of Example 1-8.
Example 10 is a computer readable medium having computer programs stored thereon which, when executed by one or more processors, cause an apparatus to perform steps of the method according to any of Example 1-8.
Example 11 is a method for a network device, including: generating a slot allocation information for transmission to a user equipment (UE), wherein the slot allocation information indicates a first slot and a second slot, and wherein the first slot is configured to communicate voice traffic and the second slot is configured to communicate traffic other than voice; and communicating the voice traffic in the first slot and the traffic other than voice in the second slot.
Example 12 is the method of Example 11, further including: generating a rank allocation information for transmission to the UE, wherein the rank allocation information indicates a first rank for the first slot and a second rank for the second slot, and wherein the first rank is smaller than the second rank; and generating a modulation and coding scheme (MCS) allocation information for transmission to the UE, wherein the MCS allocation information indicates a first MCS for the first slot and a second MCS for the second slot, and wherein the first MCS is smaller than the second MCS, wherein communicating the voice traffic in the first slot further includes: communicating the voice traffic in the first slot based on the first rank and the first MCS.
Example 13 is the method of Example 12, further including: obtaining, from the UE, a channel quality information, wherein generating the rank allocation information further includes: determining the second rank based on the channel quality information; and determining the first rank based on the second rank and a restriction of the second rank such that the first rank is smaller than the second rank.
Example 14 is the method of Example 12, further including: generating a first channel state information (CSI) report configuration for the voice traffic and a second CSI report configuration for the traffic other than voice for transmission to the UE, wherein the first CSI report configuration includes a restriction of rank indication (RI); and obtaining, from the UE, a first RI for the voice traffic and a second RI for the traffic other than voice, wherein the first RI is determined by the UE based on the restriction of RI, wherein generating the rank allocation information further includes: determining the first rank based on the first RI.
Example 15 is the method of Example 12, further including: in accordance with a determination that an antenna selection is supported, obtaining, from the UE, a sounding reference signal (SRS) channel estimation; and generating a first precoder corresponding to the first rank for transmission to the UE based on the SRS channel estimation.
Example 16 is the method of Example 12, further including: in accordance with a determination that an antenna selection is not supported, obtaining, from the UE, a precoding matrix indicator (PMI); and generating a first precoder corresponding to the first rank for transmission to the UE based on the PMI and the first rank.
Example 17 is the method of Example 16, wherein the first rank includes a predetermined number of layers, and wherein generating the first precoder corresponding to the first rank further includes: select the predetermined number of beams from the PMI.
Example 18 is an apparatus for a network device, including one or more processors configured to perform steps of the method according to any of Example 11-17.
Example 19 is a computer readable medium having computer programs stored thereon which, when executed by one or more processors, cause an apparatus to perform steps of the method according to any of Example 11-17.
Example 20 is a computer program product including computer programs which, when executed by one or more processors, cause an apparatus to perform steps of: obtaining a slot allocation information from a network device, wherein the slot allocation information indicates a first slot and a second slot, and wherein the first slot is configured to communicate voice traffic and the second slot is configured to communicate traffic other than voice; and communicating the voice traffic in the first slot and communicating the traffic other than voice in the second slot.
Example 21 is a computer program product includes computer programs which, when executed by one or more processors, cause an apparatus to perform steps of the method according to any of Example 1-8.
Example 22 is a computer program product includes computer programs which, when executed by one or more processors, cause an apparatus to perform steps of the method according to any of Example 11-17.
Example 23 is an apparatus for a communication device, including means for performing steps of the method according to any of Example 1-8.
Example 24 is an apparatus for a communication device, including means for performing steps of the method according to any of Example 11-17.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

What is claimed is:

1. One or more non-transitory, computer-readable media having instructions that, when executed, cause a user equipment (UE) to:
obtain, from a network device, slot allocation information that indicates a first slot and a second slot, wherein the first slot is configured to communicate voice traffic and the second slot is configured to communicate traffic other than voice; and
communicate the voice traffic in the first slot and the traffic other than voice in the second slot.

2. The one or more non-transitory, computer-readable media of claim 1, wherein the instructions, when executed, further cause the UE to:
obtain, from the network device, rank allocation information that indicates a first rank for the first slot and a second rank for the second slot, wherein the first rank is smaller than the second rank; and
communicate the voice traffic in the first slot based on the first rank.

3. The one or more non-transitory, computer-readable media of claim 2, wherein the instructions, when executed, further cause the UE to:
generate a sounding reference signal (SRS) channel estimation for transmission to the network device; and
obtain, from the network device, a first precoder corresponding to the first rank, wherein the first precoder is calculated by the network device based on the SRS channel estimation.

4. The one or more non-transitory, computer-readable media of claim 2, wherein the instructions, when executed, further cause the UE to:
generate a precoding matrix indicator (PMI) for transmission to the network device; and
obtain, from the network device, a first precoder corresponding to the first rank, wherein the first precoder is determined by the network device based on the PMI and the first rank.

5. The one or more non-transitory, computer-readable media of claim 2, wherein the instructions, when executed, further cause the UE to:
obtain, from the network device, a first channel state information (CSI) report configuration for the voice traffic and a second CSI report configuration for the traffic other than voice, wherein the first CSI report configuration comprises a restriction of rank indication (RI); and
generate a first RI for the voice traffic and a second RI for the traffic other than voice for transmission to the network device, wherein the first RI is determined based on the restriction of RI, and wherein the first rank is determined by the network device based on the first RI.

6. The one or more non-transitory, computer-readable media of claim 1, wherein the instructions, when executed, further cause the UE to:
obtain, from the network device, modulation and coding scheme (MCS) allocation information, wherein the MCS allocation information indicates a first MCS for the first slot and a second MCS for the second slot, and wherein the first MCS is less than the second MCS; and
communicate the voice traffic in the first slot based on the first MCS.

7. The one or more non-transitory, computer-readable media of claim 1, wherein the first slot is a virtual slot and a cycle of the first slot is aligned with a connected mode discontinuous reception (CDRX) period.

8. The one or more non-transitory, computer-readable media of claim 1, wherein the voice traffic is transmitted on one or more component carriers (CCs) of a plurality of CCs in carrier aggregation (CA), and wherein the one or more CCs for communicating the voice traffic are dynamically switched based on a trigger event.

9. A method for a network device, comprising:
generating slot allocation information for transmission to a user equipment (UE), wherein the slot allocation information indicates a first slot and a second slot, and wherein the first slot is configured to communicate voice traffic and the second slot is configured to communicate traffic other than voice; and
communicating the voice traffic in the first slot and the traffic other than voice in the second slot.

10. The method of claim 9, further comprising:
generating rank allocation information for transmission to the UE, wherein the rank allocation information indicates a first rank for the first slot and a second rank for the second slot, and wherein the first rank is smaller than the second rank; and
generating modulation and coding scheme (MCS) allocation information for transmission to the UE, wherein the MCS allocation information indicates a first MCS for the first slot and a second MCS for the second slot, and wherein the first MCS is smaller than the second MCS,
wherein communicating the voice traffic in the first slot further comprises:
communicating the voice traffic in the first slot based on the first rank and the first MCS.

11. The method of claim 10, further comprising:
obtaining, from the UE, channel quality information,
wherein generating the rank allocation information includes:
determining the second rank based on the channel quality information; and
determining the first rank based on the second rank and a restriction of the second rank such that the first rank is smaller than the second rank.

12. The method of claim 10, further comprising:
generating a first channel state information (CSI) report configuration for the voice traffic and a second CSI report configuration for the traffic other than voice for transmission to the UE, wherein the first CSI report configuration comprises a restriction of rank indication (RI); and
obtaining, from the UE, a first RI for the voice traffic and a second RI for the traffic other than voice, wherein the first RI is determined by the UE based on the restriction of RI,
wherein generating the rank allocation information further comprises:
determining the first rank based on the first RI.

13. The method of claim 10, further comprising:
in accordance with a determination that an antenna selection is supported, obtaining, from the UE, a sounding reference signal (SRS) channel estimation; and
generating a first precoder corresponding to the first rank for transmission to the UE based on the SRS channel estimation.

14. The method of claim 10, further comprising:
in accordance with a determination that an antenna selection is not supported, obtaining, from the UE, a precoding matrix indicator (PMI); and
generating a first precoder corresponding to the first rank for transmission to the UE based on the PMI and the first rank.

15. The method of claim 14, wherein the first rank comprises a predetermined number of layers, and wherein generating the first precoder corresponding to the first rank further comprises:
selecting a predetermined number of beams from the PMI.

16. An apparatus comprising:
radio-frequency (RF) interface circuitry; and
processing circuitry coupled with the RF interface circuitry, the processing circuitry to:
obtain, from a network device via the RF interface circuitry, slot allocation information, wherein the slot allocation information indicates a first slot and a second slot, and wherein the first slot is configured to communicate voice traffic and the second slot is configured to communicate traffic other than voice; and
communicate the voice traffic in the first slot and communicating the traffic other than voice in the second slot.

17. The apparatus of claim 16, wherein the processing circuitry is further to:
obtain, from the network device, rank allocation information that indicates a first rank for the first slot and a second rank for the second slot, wherein the first rank is smaller than the second rank; and
communicate the voice traffic in the first slot based on the first rank.

18. The apparatus of claim 17, wherein the processing circuitry is further to:
generating a sounding reference signal (SRS) channel estimation for transmission to the network device; and
obtaining, from the network device, a first precoder corresponding to the first rank, wherein the first precoder is calculated by the network device based on the SRS channel estimation.

19. The apparatus of claim 17, wherein the processing circuitry is further to:
generate a precoding matrix indicator (PMI) for transmission to the network device; and
obtain, from the network device, a first precoder corresponding to the first rank, wherein the first precoder is determined by the network device based on the PMI and the first rank.

20. The apparatus of claim 17, wherein the processing circuitry is further to:
obtain, from the network device, a first channel state information (CSI) report configuration for the voice traffic and a second CSI report configuration for the traffic other than voice, wherein the first CSI report configuration comprises a restriction of rank indication (RI); and
generate a first RI for the voice traffic and a second RI for the traffic other than voice for transmission to the network device, wherein the first RI is determined based on the restriction of RI, and wherein the first rank is determined by the network device based on the first RI.
